(19) United States
(12) Patent Application Publication
(10) Pub. No.: US 2012/0134857 A1
(43) Pub. Date: May 31, 2012

(54) SYNCHRONOUS AIR BLOWER HAVING A PERMANENT MAGNET MOTOR AND A HVAC SYSTEM EMPLOYING THE SAME

(75) Inventors: Harold Gene Havard, JR., Terrell, TX (US); Pantelis Hatzikazakis, Frisco, TX (US)

(73) Assignee: Lennox Industries Inc, Richardson, TX (US)

(21) Appl. No.: 12/956,480

(22) Filed: Nov. 30, 2010

(51) Int. Cl. F04B 17/00; H02P 6/14

(52) U.S. Cl. 417/362; 318/723

(57) ABSTRACT

A synchronous air blower, a HVAC system and a HVAC rooftop unit is disclosed. In one embodiment, the synchronous air blower includes: (1) a permanent magnet motor having a motor shaft with a first cogged sprocket attached thereto, (3) a fan having a fan shaft with a second cogged sprocket attached thereto and (4) a synchronous belt coupled to the motor shaft and the fan shaft via the first and second cogged sprockets, the synchronous belt having teeth configured to mate with the first cogged sprocket and the second cogged sprocket.

### CROSS REFERENCE TO RELATED APPLICATION

This application is related to U.S. patent application Ser. No. ______, (Docket No. 100041) filed by Harold Gene Havard, Jr., et al., on the same day as the present application, entitled “AIR MOVING UNIT AND AN HVAC SYSTEM EMPLOYING THE SAME”, and incorporated herein by reference in its entirety.

### TECHNICAL FIELD

This application is directed, in general, to Heating, Ventilating and Air Conditioning (HVAC) systems and, more specifically, to fans that are used to move air through the HVAC systems.

### BACKGROUND

HVAC systems can be used to regulate the environment within an enclosed space. Typically, an air blower is used to pull air from the enclosed space into the HVAC system through ducts and push the air back into the enclosed space through additional ducts after conditioning the air (e.g., heating, cooling or dehumidifying the air). Various types of HVAC systems, such as roof top units, may be used to provide conditioned air for enclosed spaces.

The HVAC business is highly competitive with manufacturers striving to provide higher efficient units and, sometimes more importantly, striving to comply with federal efficiency regulations. Additionally, manufacturing cost and system performance (e.g., noise level, low maintenance) are also factors that are considered during the design and construction of HVAC systems. Since air blowers are commonly used in HVAC systems, more efficient, higher performance and lower maintenance air blowers are desired by HVAC manufacturers. This is especially true due to the power consumption of air blower motors in HVAC systems such as rooftop units. For example, air blower motors can use approximately one third of the total power consumed by a rooftop unit. Therefore, an improved air blower can improve the overall efficiency of an HVAC system.

### SUMMARY

One aspect provides a synchronous air blower for an HVAC system. In one embodiment, the synchronous air blower includes: (1) a permanent magnet motor having a motor shaft with a first cogged sprocket attached thereto, (3) a fan having a fan shaft with a second cogged sprocket attached thereto and (4) a synchronous belt coupled to the motor shaft and the fan shaft via the first and second cogged sprockets, the synchronous belt having teeth configured to mate with the first cogged sprocket and the second cogged sprocket.

In another aspect, the disclosure provides An HVAC system. In one embodiment, the HVAC system includes: (1) a return air duct, (2) a supply air duct and (3) a synchronous air blower positioned in the HVAC system to pull return air from the return air duct and discharge conditioned air through the supply air duct. The synchronous air blower includes: (3A) a permanent magnet motor having a motor shaft with a first cogged sprocket attached thereto, (3B) a fan having a fan shaft with a second cogged sprocket attached thereto and (3C) a synchronous belt coupled to the motor shaft and the fan shaft via the first and second cogged sprockets, the synchronous belt having teeth configured to mate with the first cogged sprocket and the second cogged sprocket.

In yet still another embodiment, a HVAC rooftop unit is disclosed. In one embodiment, the HVAC rooftop unit includes: (1) a return air duct, (2) a supply air duct and (3) a synchronous air blower positioned in the HVAC rooftop unit to pull return air from the return air duct and discharge conditioned air through the supply air duct. The synchronous air blower includes: (3A) a permanent magnet motor having a motor shaft with a first cogged sprocket attached thereto, (3B) an inverter electrically coupled to the permanent magnet motor and configured to operate the permanent magnet motor at variable speeds, (3C) a scroll fan having a fan shaft with a second cogged sprocket attached thereto and having backward curved blades and (3D) a synchronous belt coupled to the motor shaft and the fan shaft via the first and second cogged sprockets, the synchronous belt having teeth configured to mate with the first cogged sprocket and the second cogged sprocket.

### BRIEF DESCRIPTION

Reference is now made to the following descriptions taken in conjunction with the accompanying drawings, in which:

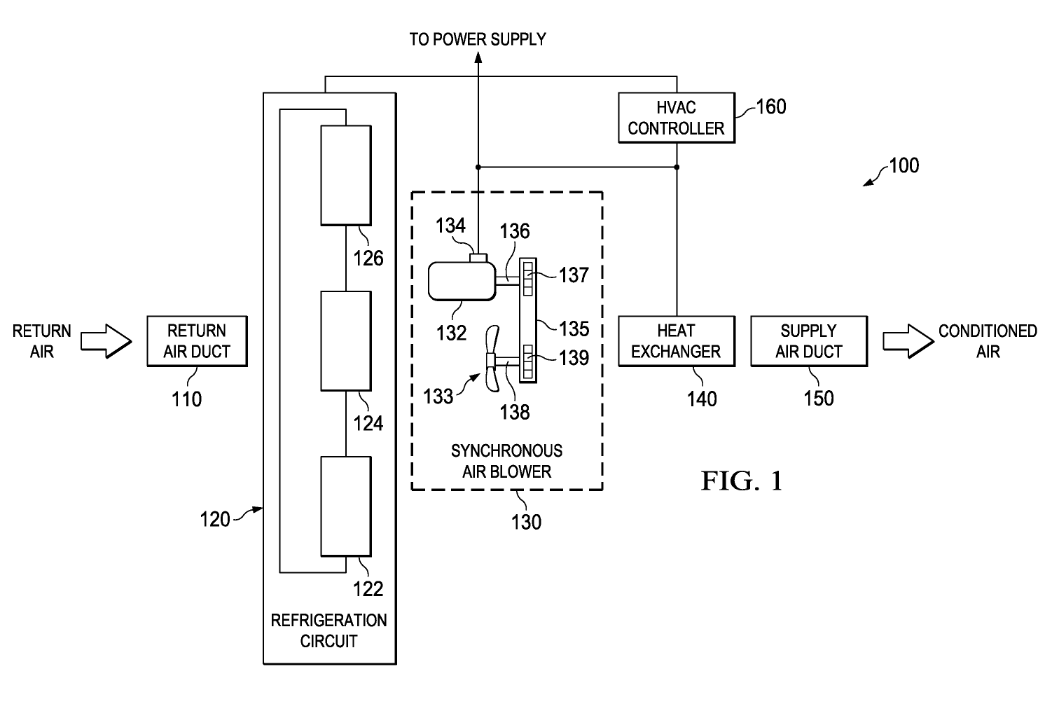

FIG. 1 illustrates a block diagram of an embodiment of an HVAC system constructed according to the principles of the disclosure;

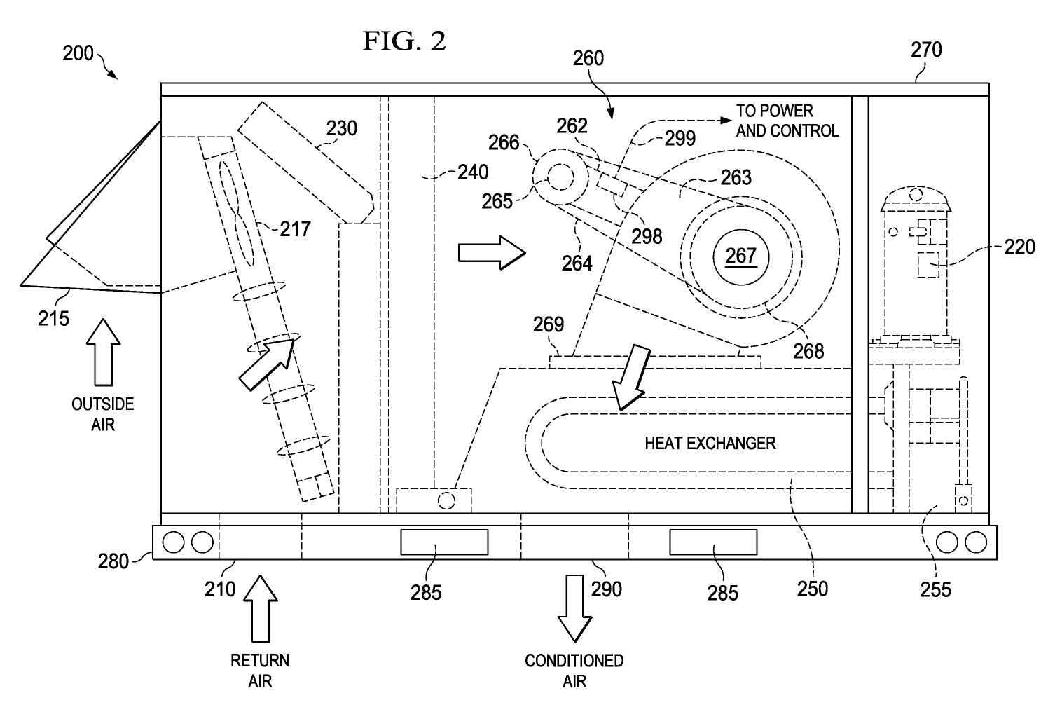

FIG. 2 illustrates a side view of an embodiment of a HVAC rooftop unit including a synchronous air blower constructed according to the principles of the disclosure; and

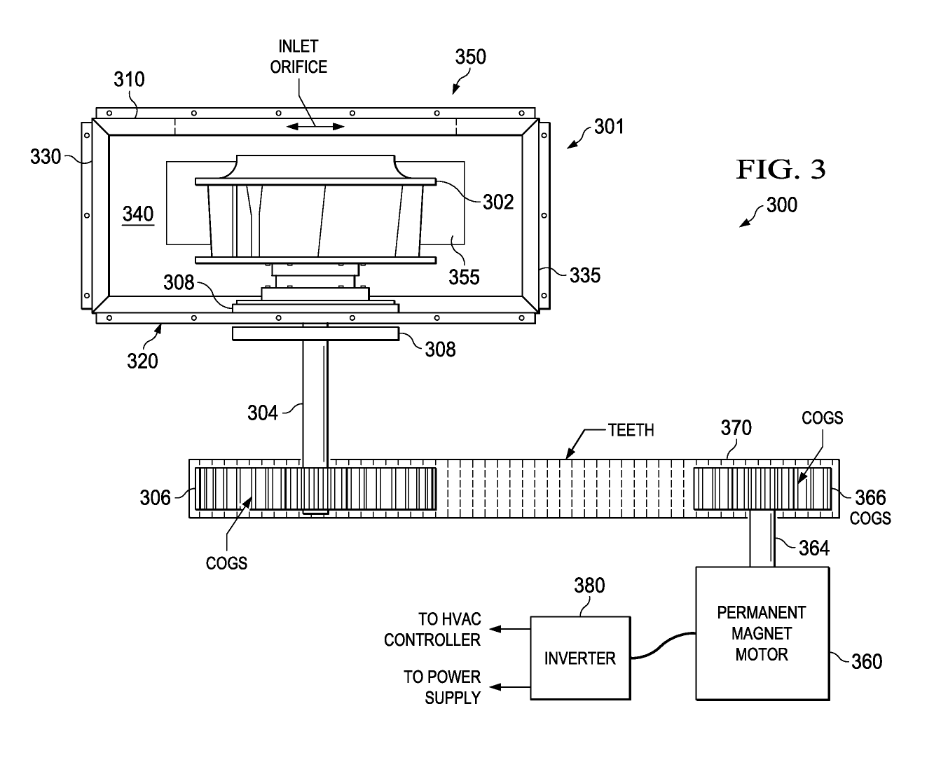

FIG. 3 illustrates a diagram of an embodiment of a synchronous air blower constructed according to the principles of the disclosure.

### DETAILED DESCRIPTION

The disclosure provides an air blower that utilizes a synchronous belt drive with a permanent magnet motor. Though synchronous belts can be noisy, the disclosed synchronous air blower can improve the efficiency of air blowers in HVAC systems by combining a permanent magnet motor with a synchronous belt to drive a fan for air circulation. Synchronous belts (also referred to as timing belts) are toothed belts that require the installation of mated tooth-driven sprockets. In comparison to V-belt systems that are typically employed in HVAC systems, a synchronous belt drive system can reduce performance degradation and reduce maintenance. Synchronous belt drive systems can also improve power transmission and reduce energy usage compared to conventional V-belts systems.

Additionally, a permanent magnet motor can provide an efficiency improvement over conventional AC motors that are employed in HVAC systems. Thus, the addition of a permanent magnet motor with a synchronous belt can further improve the efficiency of an air blower. The disclosure, therefore, provides a synchronous air blower with a permanent magnet motor for HVAC systems. The synchronous air blower may include a scroll fan or a plug fan. In one embodiment, the synchronous air blower may include an air moving unit having a circulation enclosure as disclosed in U.S. patent application Ser. No. ______. The blades of the fans may be forward or backward curved blades. An inverter is used with the permanent magnet motor to allow variable speeds and a soft-start.

FIG. 1 illustrates a block diagram of an embodiment of an HVAC system 100 constructed according to the principles of the disclosure. The HVAC system 100 includes a return air duct 110, a refrigeration circuit 120, a synchronous air blower 130, a heat exchanger 140, a supply air duct 150 and a HVAC controller 160. The refrigeration circuit 120 includes a compressor system 122, evaporator coils 124, and condenser coils 126 that are fluidly coupled together. The refrigeration circuit 120 may include multiple cooling stages.

One skilled in the art will understand that the HVAC system 100 may include additional components and devices that are not presently illustrated or discussed but are typically included in an HVAC system, such as, a power supply, an expansion valve and a condenser fan. A thermostat (not shown) is also typically employed with the HVAC system 100 and used as a user interface. The various illustrated components of the HVAC system 100 may be contained within a single housing (e.g., a cabinet). The HVAC system 100 may include multiple compartments within the housing to isolate and support the multiple components thereof. In one embodiment, the HVAC system 100 is a rooftop unit.

The return air duct 110 and the supply air duct 150 may be conventional ducts used in common HVAC systems to receive return air and discharge conditioned air. The refrigeration circuit 120, the heat exchanger 140 and the HVAC controller 160 may also be conventional devices that are typically employed in HVAC systems. The HVAC controller 160 causes the synchronous air blower 130 to move the return air across the evaporator coils 124 for cooling and through the heat exchanger 140 for heating to provide conditioned air for the conditioned air space. Operation of the HVAC system 100 can be controlled by the HVAC controller 160 based on inputs from various sensors of the HVAC system 100 and from a thermostat.

The synchronous air blower 130 includes a permanent magnet motor 132, a fan 133, an inverter 134 and a synchronous belt 135. The permanent magnet motor 132 includes a motor shaft 136 with a cogged sprocket 137 attached thereto. The fan 133 also includes a shaft, a fan shaft 138, with a cogged sprocket 139 attached thereto.

The synchronous belt 135 is coupled to the motor shaft 136 and the fan shaft 138 via the cogged sprocket 137 and the cogged sprocket 139. The synchronous belt 135 has teeth configured to mate with the cogged sprockets 137, 139. As such, when the permanent magnet motor 132 causes the motor shaft 136 to rotate, the cogged sprocket 137 rotates. Accordingly, the cogged sprocket 139 also rotates via the coupled synchronous belt 135. In response, the fan shaft 138 rotates moving blades of the fan 133 that creates a system pressure to cause air movement through the HVAC system 100.

The inverter 134 is electrically coupled to the permanent magnet motor 132 and is configured to operate the permanent magnet motor at variable speeds. The inverter 134 is also coupled to the HVAC controller 160 and a power supply. Via commands from the HVAC controller 160, the inverter 134 can control the amount of power supplied to the permanent magnet motor 132 and, therefore, vary the rotation speed thereof. The inverter 134 may be a conventional inverter employed to vary motor speeds. The inverter 134 is also employed to provide a soft-start for the permanent magnet motor 132. By slowly ramping the rotation speed of the permanent magnet motor 132 in a soft-start, damage caused by the synchronous belt 135 can be prevented. Damage can result due to the energy needed to overcome the rest momentum of the synchronous air blower 130. Ramping the rotation speed of the synchronous belt 135 can prevent damage or destruction of the various components of the HVAC system 100 including the synchronous air blower 130.

The fan 133 may be of different types. Regardless of the type of fan, the fan 133 may have blades that are backward curved blades. In other embodiments, the fan blades may be forward curved blades. As such, the disclosed synchronous fan 130 may employ forward curved blower technology and backward curved blower technology. In one embodiment, the fan 133 may be a scroll fan. In another embodiment, the fan may be a plug fan. In yet another embodiment, the fan 133 may be a serviceable plug fan unit with a circulation enclosure. The circulation enclosure may be a rectangular parallelepiped-shaped enclosure. With a serviceable plug fan unit, the shaft of the open blower wheel of the plug fan extends out of the enclosure for coupling to the synchronous belt 135 via a cogged sprocket.

The permanent magnet motor 132 may be a foot mounted motor. Depending on the type of the fan 133, the permanent magnet motor 132 may be mounted to the scroll of the fan 133 or, in alternative embodiments, may be mounted to the circulation enclosure of the fan 133. The permanent magnet motor 132 may be mounted in other locations within the HVAC system 100 that allow alignment of the synchronous belt 135 between the cogged sprockets 137, 139. In one embodiment, the permanent magnet motor 132 may be mounted on a blower deck of the HVAC system 100.

FIG. 2 illustrates a side view of an embodiment of a HVAC rooftop unit 200 including a synchronous air blower 260 constructed according to the principles of the disclosure. The HVAC rooftop unit 200 includes a return air duct 210, an outdoor air duct 215, dampers 217, a compressor system 220, filters 230, an evaporator coil 240, a heat exchanger 250, a gas supply 255 and the synchronous air blower 260. The HVAC rooftop unit 200 also includes a housing 270, a base 280 with forklift slots 285 and a supply air duct 290. The return air duct 210 and the supply air duct 290 are represented by dashed lines through the base 280 in this side view. The HVAC rooftop unit 200 includes additional components that are not visible from this view due to various walls, compartments or equipment, but are typically included in conventional HVAC rooftop units. For example, the HVAC rooftop unit 200 may also include a power supply, a controller, condenser coils and a condenser fan(s).

An air flow path through the HVAC rooftop unit 200 is represented by the arrows. Air is received in the HVAC rooftop unit 200 via the return duct 210 (i.e., return air) and/or the outside air duct 215 (i.e., outside air). The dampers 217 can be controlled to determine the air mixture. The received air (e.g., return, outside or a mixture thereof) is then pulled across the filters 230, the evaporator coil 240 and discharged to a conditioned space via the heat exchanger 250 and the supply air duct 290. The air discharged through the supply air duct 290 to the conditioned space may be conditioned due to either a cooling mode or a heating mode of the HVAC rooftop unit 200.

The synchronous air blower 260 pulls the received air through the HVAC rooftop unit 200 and discharges conditioned air through the supply air duct 290. Accordingly, the synchronous air blower 260 is positioned in the HVAC rooftop unit 200 to pull return air from the return air duct and discharge conditioned air through the supply air duct. The synchronous air blower 260 includes a permanent magnet motor 262, a scroll fan 263 and a synchronous belt 264. The permanent magnet motor 262 is a foot mounted motor that is mechanically attached to the scroll 260 of the scroll fan 263. The permanent magnet motor 262 includes a motor shaft 265 with a cogged sprocket 266 attached thereto. The scroll fan 263 includes a fan shaft 267 and a cogged sprocket 268 attached. Additionally, the scroll fan 263 includes backward curved blades (not visible in this view) that pull the received air through the HVAC rooftop unit 200. The synchronous belt 264 is coupled to the permanent magnet motor 262 and the scroll fan 263 via the cogged sprockets 266, 268. The synchronous belt 264 includes teeth that mate with cogs of the cogged sprockets 266, 268, to rotate the fan shaft 267 via the motor shaft 265.

The synchronous air blower 260 further includes an inverter 298 that is electrically coupled to the permanent magnet motor 262 and configured to operate the permanent magnet motor at variable speeds. The inverter 298 may also be mechanically coupled to the permanent magnet motor 262 or, alternatively, may be positioned in another location within the HVAC rooftop unit 200. The inverter 298 is electrically coupled to an HVAC controller and a power supply of the HVAC rooftop unit 200 via the power and control wiring 299. The power and control wiring 299 may be connected to the inverter 298 via conventional means. In addition to providing variable-speed capability for the permanent magnet motor 262, the inverter 298 is also configured to soft start the permanent magnet motor 262 in order to prevent damage to the synchronous air blower 260.

The HVAC rooftop unit 200 also includes the blower deck 269 in which the synchronous air blower 260 is mounted. The blower deck 269 is typically constructed to slide or roll to allow easier access to the synchronous air blower 260. The blower deck 269 is usually constructed of a metal sufficiently rigid to support the synchronous air blower 260. The blower deck 269 may be coupled to the base 280 for support. The blower deck 269 also includes an opening (not visible) that corresponds to the supply air duct 290 for discharging air.

FIG. 3 illustrates a diagram of an embodiment of a synchronous air blower 300 constructed according to the principles of the disclosure. The synchronous air blower 300 includes a circulation enclosure 301 and a plug fan 302. The circulation enclosure 301 has a front side 310, a back side 320, a right side 330, a left side 335 and a bottom side 340. Additionally, the synchronous air blower 300 includes a top side that has been removed in this top view of the synchronous air blower 300. The sides of the circulation enclosure 301 may be a type of metal, such as aluminum. The edges of each of the multiple sides of the circulation enclosure 301 include a flange with openings for connecting to each other. Screws or other mechanical means may be used to fix the multiple sides together to form the circulation enclosure 301. One skilled in the art will understand that other mechanical means may be employed to couple the sides together to form the circulation enclosure 301.

The synchronous air blower 300 includes an inlet orifice 350 for pulling air into the circulation enclosure 301 and a supply air opening 355 located on the bottom side 340 for discharging air out of the circulation enclosure 301. In some embodiments, the supply air opening 355 may be separated into two distinct openings. The plug fan 302 is positioned inside of the circulation enclosure 301. As such, the plug fan 302, or at least the blower wheel, is substantially enclosed by the sides of the circulation enclosure 301. In this embodiment, access to the blower wheel is only provided via the inlet orifice 350 and the supply air opening 355. By positioning the plug fan 302 within the circulation enclosure 301, service technicians are protected from the blades of the blower wheel. In FIG. 3, the plug fan 302 has a blower wheel with backward curved blades that create a pressure when rotated to move air through an HVAC system. In other embodiments, other type of blades may be used.

The plug fan 302 includes a fan shaft 304 with a cogged sprocket 306, and a fan mount 308. A rotation center of axis of the plug fan 302 corresponds to the center of the inlet orifice 350 and the fan shaft 304. The fan shaft 304 extends through an opening in the back side 320, a motor opening. The fan mount 308 fixes the plug fan 302 to the circulation enclosure 301 around the motor opening and supports the plug fan 302. In addition, the mounting structure 308 stabilizes the plug fan 302 when operating. The fan mount 308 may be a conventional device with coupling plates designed to mount and support fans to a wall with a through-hole for the fan shaft 304. Through bolts may be used to couple the plates of the fan together with the back side 320.

The circulation enclosure 301 has a rectangular parallelepiped shape. A length (L) of the circulation enclosure 301 along a first axis that is perpendicular to the fan shaft 304 is greater than a width along a second axis that is parallel with the fan shaft 304. The location of the plug fan 302 within the circulation enclosure may vary depending on the type of HVAC unit the synchronous air blower 300 is employed. As such, the fan shaft 304 may be centered or off-centered on the back side 320 with respect to the distance between the left side 335 and the right side 330. For example, the fan shaft 302 may be offset from the left side 335 a distance that is equal to half of L, greater than half of L or less than half of L. The mounting height of the plug fan 302 from the bottom side 340 may also vary depending on the type of HVAC unit in which the synchronous air blower 300 is employed and the dimensions of the plug fan 302 that is used.

The synchronous motor 300 also includes a permanent magnet motor 360 having a motor shaft 364 with a cogged sprocket 366 attached thereto. A synchronous belt 370 couples the motor shaft 364 and the fan shaft 304 via the cogged sprockets 306, 366. The synchronous belt 370 includes teeth configured to mate with cogs of the cogged sprocket 306 and the cogged sprocket 366. The synchronous air blower 300 also includes an inverter 380 electrically coupled to the permanent magnet motor 360. The inverter 380 is also electrically coupled to a controller and a power supply and is used to operate the permanent magnet motor 360 at variable speeds and provide a soft start-up.

Those skilled in the art to which this application relates will appreciate that other and further additions, deletions, substitutions and modifications may be made to the described embodiments. For example, the supply air opening may be located on different sides of the circulation enclosure than the bottom side. In some embodiments, the supply air opening may be on the left side, the right side, the back side or the top side. The location of the supply air opening may depend on the configuration of the HVAC unit in which the synchronous air blower is employed.

What is claimed is:

1. A synchronous air blower for an HVAC system, comprising:
a permanent magnet motor having a motor shaft with a first cogged sprocket attached thereto;
a fan having a fan shaft with a second cogged sprocket attached thereto; and
a synchronous belt coupled to said motor shaft and said fan shaft via said first and second cogged sprockets, said synchronous belt having teeth configured to mate with said first cogged sprocket and said second cogged sprocket.

2. The synchronous air blower as recited in claim 1 further comprising an inverter electrically coupled to said permanent magnet motor and configured to operate said permanent magnet motor at variable speeds.

3. The synchronous air blower as recited in claim 2 wherein said inverter is configured to soft start said permanent magnet motor.

4. The synchronous air blower as recited in claim 1 wherein said fan has backward curved blades.

5. The synchronous air blower as recited in claim 1 wherein said fan is a scroll fan.

6. The synchronous air blower as recited in claim 5 wherein said permanent magnet motor is a foot mounted motor and is mechanically coupled to a scroll of said scroll fan.

7. The synchronous air blower as recited in claim 4 wherein said fan is a plug fan.

8. The synchronous air blower as recited in claim 4 wherein said fan is a serviceable plug fan unit with a circulation enclosure.

9. The synchronous air blower as recited in claim 1 wherein said fan has forward curved blades.

10. An HVAC system, comprising:
a return air duct;
a supply air duct; and
a synchronous air blower positioned in said HVAC system to pull return air from said return air duct and discharge conditioned air through said supply air duct, said synchronous air blower including:
a permanent magnet motor having a motor shaft with a first cogged sprocket attached thereto;
a fan having a fan shaft with a second cogged sprocket attached thereto; and
a synchronous belt coupled to said motor shaft and said fan shaft via said first and second cogged sprockets, said synchronous belt having teeth configured to mate with said first cogged sprocket and said second cogged sprocket.

11. The HVAC system as recited in claim 10 further comprising an inverter electrically coupled to said permanent magnet motor and configured to operate said permanent magnet motor at variable speeds.

12. The HVAC system as recited in claim 11 wherein said inverter is configured to soft start said permanent magnet motor.

13. The HVAC system as recited in claim 10 wherein said fan has backward curved blades.

14. The HVAC system as recited in claim 10 wherein said fan is a scroll fan.

15. The HVAC system as recited in claim 14 wherein said permanent magnet motor is a foot mounted motor and is mechanically coupled to a scroll of said scroll fan.

16. The HVAC system as recited in claim 10 wherein said fan is a plug fan.

17. The HVAC system as recited in claim 10 wherein said fan is a serviceable plug fan unit with a circulation enclosure.

18. The HVAC system as recited in claim 17 wherein said circulation enclosure has a rectangular parallelepiped shape.

19. An HVAC rooftop unit, comprising:
a return air duct;
a supply air duct; and
a synchronous air blower positioned in said HVAC rooftop unit to pull return air from said return air duct and discharge conditioned air through said supply air duct, said synchronous air blower including:
a permanent magnet motor having a motor shaft with a first cogged sprocket attached thereto;
an inverter electrically coupled to said permanent magnet motor and configured to operate said permanent magnet motor at variable speeds;
a scroll fan having a fan shaft with a second cogged sprocket attached thereto and having backward curved blades; and
a synchronous belt coupled to said motor shaft and said fan shaft via said first and second cogged sprockets, said synchronous belt having teeth configured to mate with said first cogged sprocket and said second cogged sprocket.

20. The HVAC rooftop unit as recited in claim 19 wherein said permanent magnet motor is a foot-mounted motor and is mechanically coupled to a scroll of said scroll fan.
